(19) United States
(12) Patent Application Publication
(10) Pub. No.: US 2009/0016054 A1
(43) Pub. Date: Jan. 15, 2009

(54) LED night light with projection feature

(76) Inventor: Tseng-Lu Chien, Shi-Chi Town (TW)

Correspondence Address: BACON & THOMAS, PLLC, 625 SLATERS LANE, FOURTH FLOOR, ALEXANDRIA, VA, 22314-1176, US

(21) Appl. No.: 12/232,505

(22) Filed: Sep. 18, 2008

Related U.S. Application Data
(63) Continuation of application No. 11/092,742, filed on Mar. 30, 2005.

(51) Int. Cl. F21V 21/14

(52) U.S. Cl. 362/250

(57) ABSTRACT

The current invention for LED night light for night time or dark area use including plug-in wall outlet night light or direct current operated night light with projection features to project the image, message, data, logo, time on ceiling, walls, floor, desired surface. The said LED night light incorporated with optics means may selected from group combination from optics-lens, convex lens, concave lens, openings, cut-outs, film, grating means, hologram means (same as inventor's U.S. Pat. No. 5,667,736) to create the preferred image on the desired location to let viewer to see.

This is continuation of US patent application Series No. Filed on Apr. 28, 2008 file for the “Removable LED light device.

This is continuation of U.S. patent application Ser. No. 12/073,889 Filed on Mar. 25, 2008 file for the LED track light device.

This is Continuation of U.S. patent application Ser. No. 12/073,095, filed on Feb. 29, 2008 file for the “LED light with changeable position with Preferable power source”.

This is Continuation of U.S. patent application Ser. No. 12/007,076, filed on Jan. 7, 2008 file for the “LED light with changeable geometric system”

This is Continuation of U.S. patent application which the Ser. No. 12/003,691, filed on Dec. 31, 2007 file for the “LED light with changeable geometric dimension features”

This is Continuation of U.S. patent application which the Ser. No. 12/003,809, filed on Jan. 2, 2008 file for the “LED light with changeable features”

This is Continuation of U.S. patent application which the Series No. 11/806,711 filed on Jun. 8, 2007 file for the “Multiple LED light with adjustable angle features”

This application is continuation of U.S. patent application LED Night light with interchangeable display unit, Ser. No. 11/527,631.

This application is continuation of U.S. patent application Ser. No. 11/498,881, Poly Night light

This application is continuation of U.S. patent application Ser. No. 11/255,981, Multiple light source Night Light.

This application is continuation of U.S. patent application LED Night light with Liquid optics medium Ser. No. 11/094,215, filed Mar. 30, 2005.

This application is continuation of U.S. patent application Night light with fiber opotics Ser. No. 11/092,741, filed Mar. 30, 2005.

This application is continuation of U.S. patent application Fiber Optic light kits for footwear Ser. No. 10/883,747, filed Jul. 6, 2004.

This application is continuation of U.S. patent application Area Illumination for LED night light Ser. No. 11/498,874,

This application is continuation of U.S. patent application Time Piece with LED night light, Ser. No. 11/527,629.

This application is continuation of U.S. patent application Multiple Function Night light with Air Freshener, Ser. No. 11/527,628.

This application is continuation of U.S. patent application LED Night light with more than one optics mediums, Ser. No. 11/806,284

This application is continuation of U.S. patent application LED Night Light with multiple function, Ser. No. 11/806,285

This application is continuation of U.S. patent application Multiple LEDs Light with adjustable angle function, Ser. No. 11/806,711

### BACKGROUND

The current invention offer light image to wall, ceiling of desired location to make people view the desired image such as stars, moon, planet, silver-river, universal image to let people have pleasure mood to stay under dark environment or fall a sleep under nice environment. Especially for youth or kids room applications will be important to let them have their own favorite image surround them.

The current invention for LED light for night time use including the plug-in wall outlet night light or direct current (hereafter as DC) operated night light with projection features to project the image, message, data, logo, time on ceiling, walls, floor, desired surface.

The current invention has light source by LED or LEDs (same as co-pending filing for Ser. No. 11/255,981 which is allowance) to offer the visible light beam passing though optics means or more than one of the optics means (same as co-pending filing Ser. No. 11/806,284) and create image on the desired location with preferable features may selected from group combination from size, dimension, area, height, distance, color, brightness, time period, trigger means.

The current invention incorporated with preferred optics means from group combination from optics-lens, concave lens, openings, cut-outs, film, grating means, hologram means (same as inventor's U.S. Pat. No. 5,667,736) to create the preferred image on the desired location to let viewer to see.

The current invention combined the inventor's co-pending Ser. Nos. 11/255,981 and 11/806,284 for more than one light source and optics means with inventor's U.S. Pat. No. 5,667,736 grating or hologram technical can created a lot of images to get best image projection on the wall or ceiling or floor for requirement.

### DRAWINGS

FIG. 1 and FIG. 3: Disclosure the 1^{st} and 3^{rd} preferred embodiment for LED night light with image projection function. These preferred night lights are plug-in type to connect with electric outlet. FIG. 1 item is incorporated with opening, cutout, transparent, translucent as optics means to create image. The FIG. 3 items is incorporated with convex-lens assembly and film as optics means to create image with position change feature.

FIG. 2: Disclosure the current invention's image projection on the wall or ceiling or floor of people's living place by plug-in type night light or battery operated LED night light.

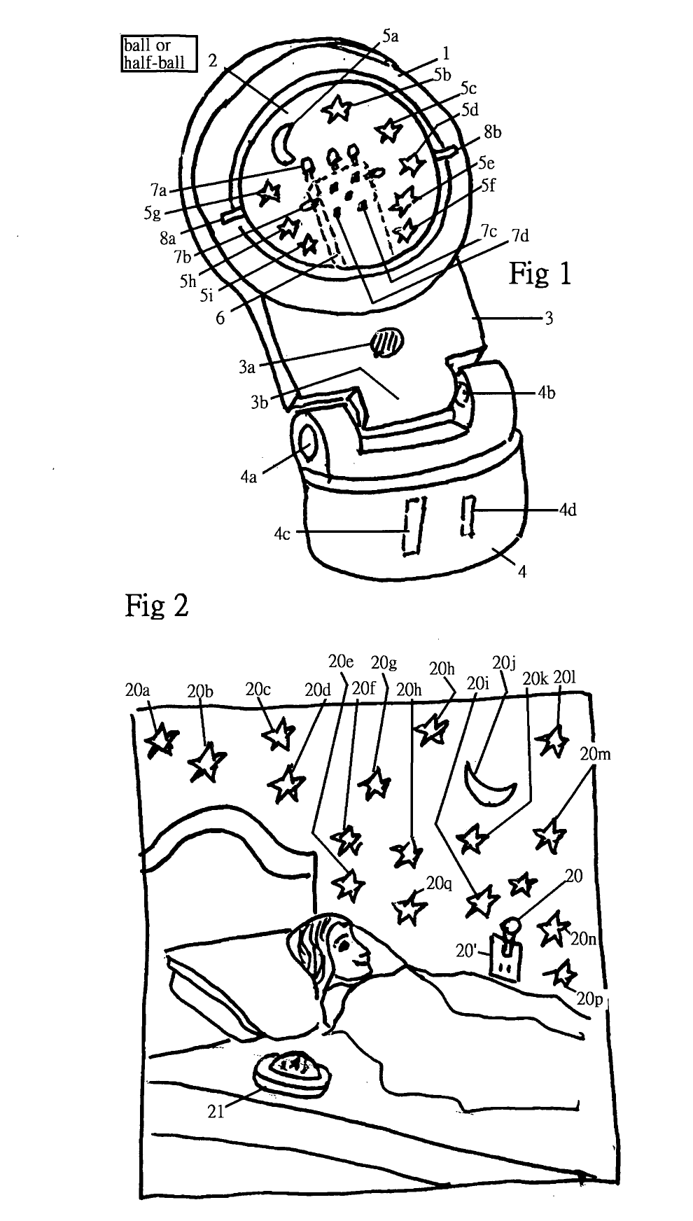

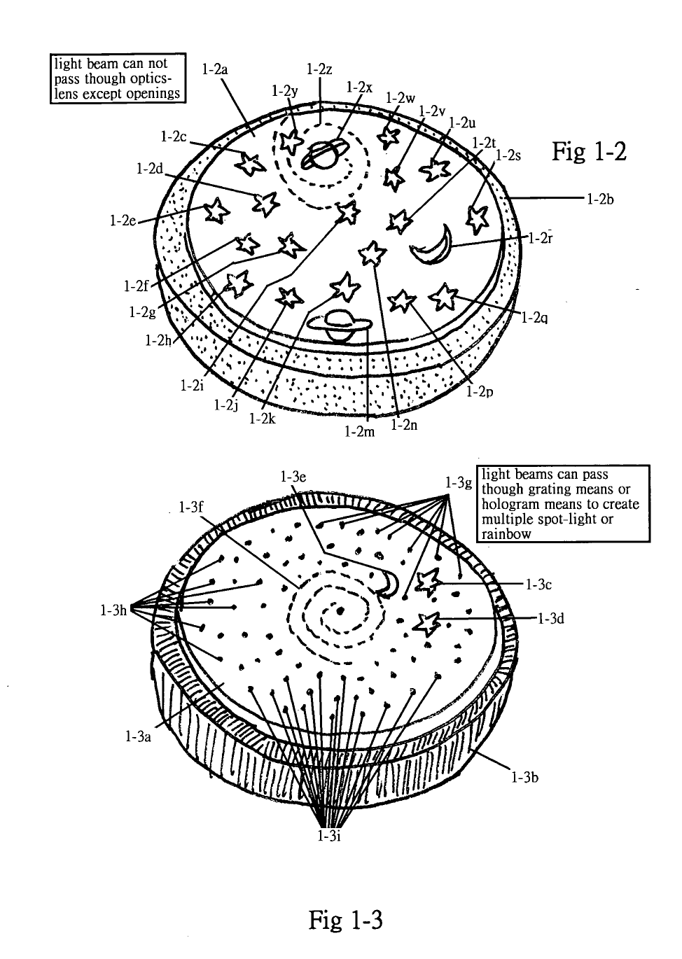

FIG. 1-2 and FIG. 1-3: Disclosure the 2^{nd} and 4^{th} preferred embodiment of direct current (DC) operated LED night light with different optics means applied which may selected from openings, cut-outs, transparency, translucent, grating means, hologram means, film to make the images on desired location.

FIG. 4: Disclosure the details construction of the said 3rd preferred embodiment of plug-in type of Night light with convex-lens assembly and film as optics means and projecting the desired image.

FIG. 5: Disclosure the alternative construction of the FIG. 4 to install the convex-lens assembly into a ball-unit which can be change position as required so can project the image on desired location and has its preferred trigger-means.

FIG. 6, Disclosure the alternative construction of the FIG. 4 with shaped housing to make said current invention night light with attractive shape.

FIG. 7 and FIG. 8: Disclosure the optics means for FIG. 1,4,5,6 which is convex-lens assembly with desired image film. The convex-lens assembly with image size different while people view from two ends of the said convex-lens assembly.

FIG. 9: Disclosure the details light source and power source and circuit means and trigger means for the said Battery Operated Night light device.

FIG. 10: Disclosure the details construction for the direct current operated night light with touch top optics means to turn on the light with optional timer-means to make the certain time period for illumination and turn-off automatically. It also can have motion sensor, photo sensor means to be selected as required.

### DETAIL DESCRIPTION

The LED night light with projection features of current invention is different from convention market place's projection pen, projection key chain, projection toy, or commercial presentation projection equipment.

The current invention mainly for the night light applications with LED or LEDs as light source to directly plug into outlet device, so the circuit need to be special design to fit for the AC 110V 60 Hz input power to drive the said LED or LEDs.

The current invention also applied for direct current (DC) operated night light which to turn on the said LED or LEDs by pushing the optics-lens. This is same as conventional punk light to drive LED or LEDs turn on. The current invention made big improvements to add optics design for the said opaque-lens from the conventional punk light. The current invention incorporated optics-means which may selected from group combination from optics-lens, convex lens, concave lens, telescope, film, grating means, hologram means, transparent material, translucent material, openings, cut-outs with precision optics calculation and optics design to make the said image, message, logo, characters, sign, time, data to project on the desired surface such as ceiling, walls, floor, or any location as wished.

The current invention also disclosure the geometric design for the whole night light, it is not limited to the preferred embodiments. The alternative construction for the night light with tilt, swivel, rotating, position change, focus adjustable, still fall within the current invention scope.

From FIG. 1, The LED night light with a top housing (1) to hold the ball-shape optics-lens (2). The ball-shape optics-means (2) has a lot of opening (5a to 5i) with desired shape such as moon (5a), stars (5b to 5i), planets (not shown). The each opening size and shape are under optics designed so can allow the inner LED or LEDs (7a to 7d) light beams can passing though these openings (5a to 5i) to form a clear and nice image on the desired surface. The image on the desired surface with different distance, height so the optics design for the light source v.s. openings need to consider so the image will be very clear to shown on the desired surface.

From FIG. 1, The Optics-lens (2) is a ball shape or half-ball shape or approximately sphere surface which is the preferred design because it can has more images shown on the 3 dimensional space. The alternative geometric shape still can be applied on the current invention as long as market accepted the image performance. Any alternative shape of the optics-means is still fall within the current invention scope just for different range of projection area.

From FIG. 1, the LED or LEDs (7a to 7d) are arranged on the circuit-means (6) which has electric parts and accessories to drive the incoming electric signal to the said LED or LEDs working voltage and frequency with desired electric components incorporated the circuit-means (6) to get desired light function such as IC, sensor-means, switch-means, timer, resistor, capacitor or any conventional market available parts and accessories.

From FIG. 1, The base housing (4) can assemble with the top housing (1) by attach-means from end (4c) to end (4d) so can make the top housing (1) swivel to the base housing (4). The base housing with prong means (4a) (4b) to connect with the outlet device. The prong means (4a) (4b) also can design as swivel type as wished.

From FIG. 2, show the function of the LED night light (20) (21) with projection features. The plug-in night light (20) plug into the wall outlet to make projection on the desired location such as ceiling, walls, floor. The direct current (DC) operated LED night light (21) has the image projection on the desired location as wished.

From FIG. 1-2, The direct current (DC) operated LED night light has the optics-lens (1-2a) are well install on the base (1-2b). The optics-lens (1-2a) has proper design for the optics so can allow the inner LED or LEDs' light beam to pass though these optics-means to create the image, logo, sign, data, message shown on desired surface. The optics-lens (1-2a) which is sphere shape which can not allow the light passing though any place of the optics-lens (1-2a) except all the openings (1-2a to 1-2z). The inner light source and outside openings has details optics design to make the LED or LEDs' light beam can passing though the openings to make a clear image on the desired surface. The distance between the openings and the LEDs need to be designed. The LED viewing angle need to be designed. The size of each openings need to be designed. The openings (1-2a to 1-2z) can be any shape such as stars (1-2c to 1-2k), moon (1-2r), planet (1-2x) (1-2m), silver-river (1-2z).

From The FIG. 1-3, The direct current (DC) operated LED night light has the optics-lens (1-3a) are well install on the base (1-3b). The optics-lens has proper design for the optics so can allow the inner LED or LEDs' light beam to pass though these optics-means to create the image, logo, sign, data, message shown on desired surface. The optics-lens (1-3a) which is sphere shape which also the light passing though anywhere of the said optics-lens because this optics-lens incorporated the grating or hologram means so limited LED or LEDs light points will create multiple of light-spots (1-3h) (1-3i) or rainbow-effects (not shown) on whole surface and project to the desired surfaces with these effects. The optics-lens (1-3a) is made by injection-process as inventor's U.S. Pat. No. 5,667,736. The optics-lens also can be any type of transparency or translucent lens incorporated with the grating or hologram film to make the multiple light-spots (1-3h) (1-3i) or rainbow-effects (not shown) on the lens and project to the desired surface with those effects. This will make the DC operated night light with projection effects and keep the kids or youth enjoy the mood of the image, characters, logo, message, time display under dark environment.

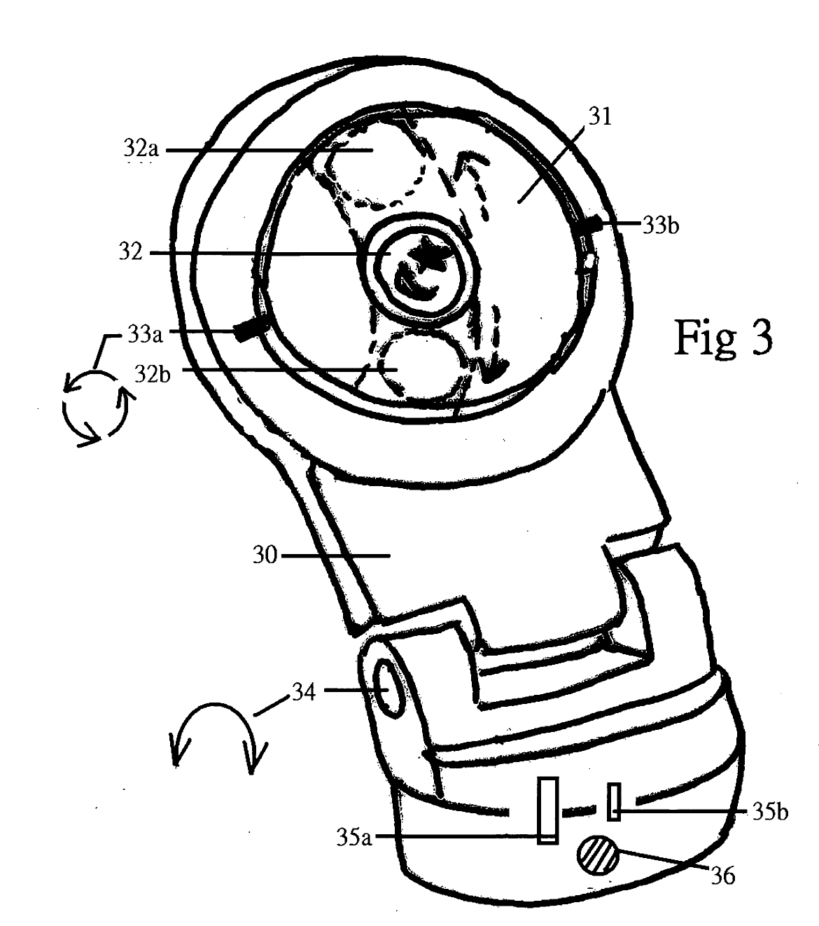

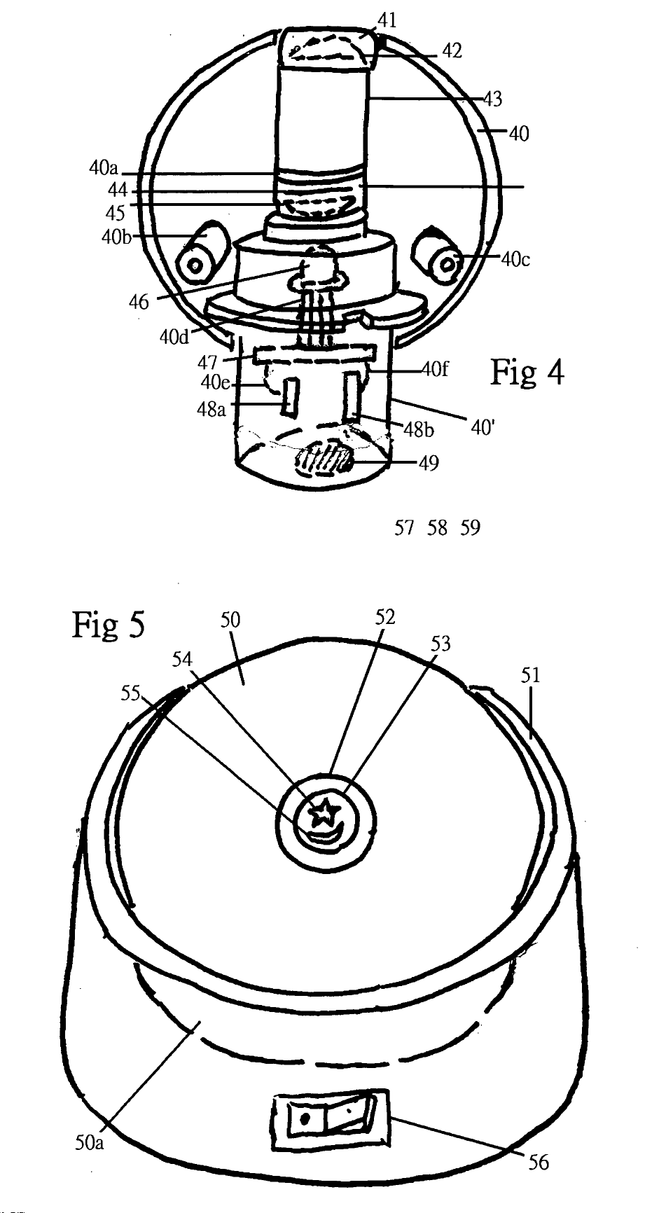

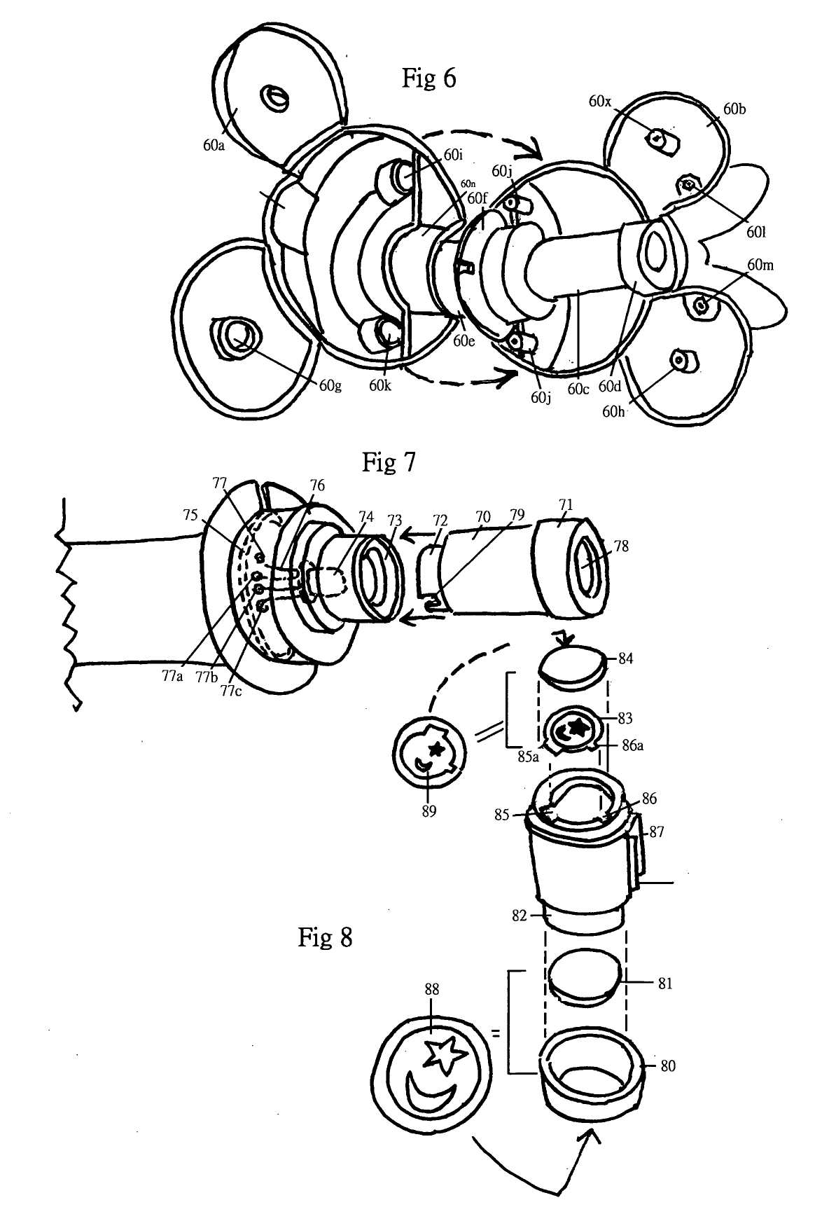

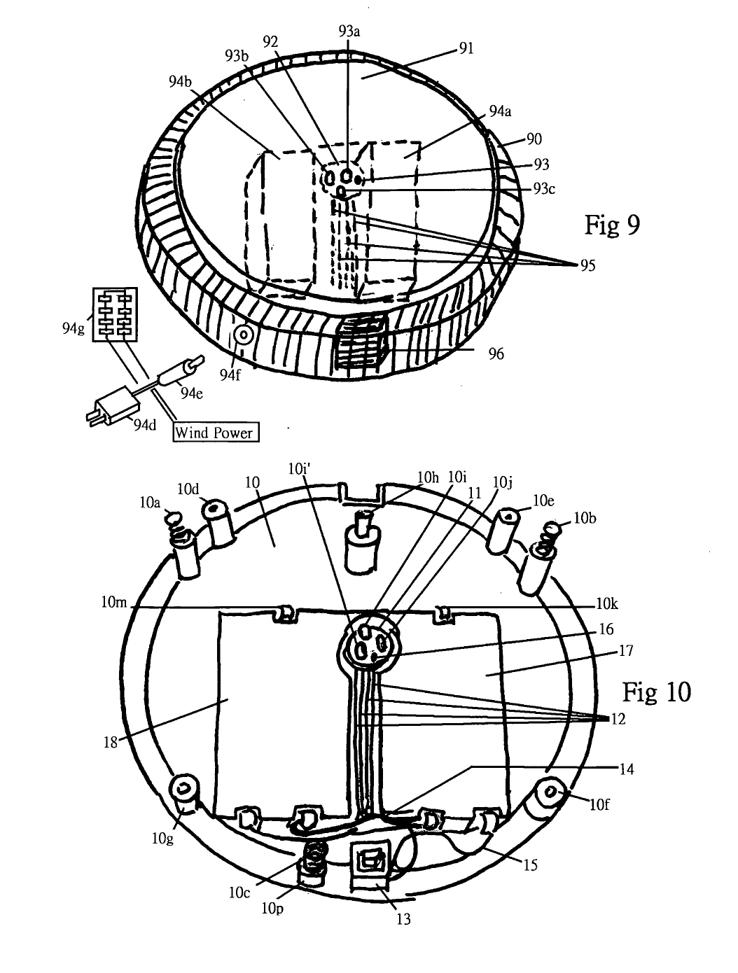

From FIG. 3, The LED night light with projection feature has top housing (30) with ball-shape optics-lens (31) with two poles (33a) (33b) to allow the ball (31) can be rotating to change the projection position from (32a) to (32b) while the projection fix on the position (32). This features may adapted while the plug-in night light is not swivel-housing design. From FIG. 3, this is swivel-housing design night light incorporated with optics-means by optics-lens assembly. The swivel-housing with top housing (30) and base housing (34) get together by attach-means to make the top housing (30) can be swivel to desired position while plug into wall outlet.

From FIG. 3, the LED night light with projection features has the prong means (35a) (35b) and sensor means (36). The light will turn on while the environment brightness dropped to designed level and the night light will turn on automatically.

From FIG. 4, Disclosure the ball-shaped Night light (40) which has the optics-lens assembly which including convex lens (42) install within the telescope body (43) and hold by cover (41) on top portion. The other end of the telescope body (43) has image film (44) and convex lens (45) by clipping-tight on position which position with LED (46) to get the light beam to pass though the convex lens (45) to image film (44) to telescope length (43) to convex lens (41) to shown on the desired surface for the enlarge size of the Image.

The telescope (43) with optics-lens assembly (45) (44) main purpose to enlarge the tiny size image on the film (44) become a big image to project to the desired surface. The telescope construction can be more advanced for “focus adjustable” so can make the enlarge size image on desired surface for more clear image. This is still fall within the current invention while market need this deluxe model.

The LED or LEDs (46) are connected with circuit means which may has variety electric components may selected from any combination of conductive means (40e) (40f), circuit board (47), Integrated circuit (hereafter as IC), sensor means, switch means, motion sensor, timer, photo sensor (49), resilient conductive means or other electric components from conventional available parts or accessories. These electric components can make the said LED or LEDs with desired light function and light performance as other LED light device has in market place.

The LED night light with projection features as FIG. 4 which is applied the optics-lens assembly and telescope means to make the tiny image on film to project to big surface. The same construction are applied on FIG. 3 but the FIG. 3 telescope means can be change position while the ball is rotating so can change the projection image location to different direction.

From FIG. 5 disclosure the alternative construction for the full ball (50) has telescope means (53) and optics-lens assembly (not shown) inside of the ball. The direction of the telescope (53) can be change while the ball (50) can be rotating to other direction. The image of star (54) and moon (55) can be projected to desired surface for much larger image. It also can be adjust focus while twist the front cover so can change the length of the telescope to change focus to get image clearance to desired image.

From FIG. 6 disclosure telescope means (60c) and optics-lens assembly (60d) inside the two half housing (60a) (60b). The two half of the housing (60a) (60b) are assembly together by screw though the pole (60j′) (60j) and holder (60i) (60k).

From FIG. 7 disclosure details construction of the telescope (70) with top portion (71) has the convex lens (78) inside. The other end (72) of the telescope (70) has the film (not shown) and convex lens (not shown) clip-tight on location to make the tiny image on the film become large on the top of the telescope. The end (72) are insert into the receiving end (73) so the LED light beam can input to the telescope to make the image project to the desired surface. The LED (74) are install on the inner circuit-means and connect with preferred power source from outlet or batteries to make the LED turn on under predetermined time, function, duration, effects.

From FIG. 8 disclosure the details construction of the telescope (87) which has the top cover (80) to hold the convex lens (81) on position. The other end of telescope (87) has two ditch (85) (86) to allow hold the film's two extend-ends (85a) (86a) so can hold the film on position without any deviation of position. The small convex-lens (84) are clip-tight on telescope. The image to be seen from the small end of telescope will be as image (89) so tiny. The image to be seen from the front of the telescope will be as image (88) the image is very large because the telescope enlarge the tiny image to the bigger size.

From FIG. 9 disclosure the DC operated night light device and its electric components which has optics-means (91) on top of the base (90). The inner electric construction including power source compartment (94a) (94b) which may have 3 pieces of batteries of each compartment so can get the voltage approximately 4.5 Volt. It also can have different power source arrangement which may selected from different voltage (3V, 6V, 9V, 12V, 24 v), different DC power source, solar power (94g), generator, wind power, chemical power, alkaline battery, rechargeable battery, AC adaptor (94d) (94e) with adaptor jack (94e), AC power (94c).

From FIG. 9, The LED or LEDs (93a) (93b) (93c) connected with circuit-means which may selected from group combination from circuit board (92), integrated circuit (93), conductive means (95), switch means (96), AC jack (94f), solar module (94g), AC plug and wire (94c), AC adaptor (94d), sensor means, motion sensor means, timer means to make the desired light functions and effects.

From FIG. 9 disclosure the DC operated night light circuit arrangement which has the switch means (13) located on the position under the edge of the optic-lens (not shown). While the optic-lens been pushed the switch will be turn on the LED or LEDs for illumination under predetermined functions and time period of time. The LED or LEDs incorporated with the circuit means to get the desired functions. The spring means (10a) (10b) (10c) offer the resilient properties to make the optics-lens can be push down and push back to original position to next push. The Integrated circuit (16) is IC Chip which can offer a lot of functions which can selected from conventional market light functions.

From above discussed and mentioned of preferred embodiments to show the scope of the current and co-pending invention, it is appreciated that any alternative or equivalent functions of design, construction, modification, up-grade still fall within the scope of the invention but not limited to all above discussion and mentioned details.

The alternative or equivalent arrangement, process, installation or the like design, changes from the current invention still fall within the scope of the current invention.

Including power source, conductive means, geometric shape of LED-units, join-means, circuit means, sensor means, switch means, LED elements, attachment means, fix-means, tighten means, resilient conductive means may has alternative arrangement, design, constructure. From above discussed and mentioned of preferred embodiments to show the scope of the current and co-pending invention, it is appreciated that any alternative or equivalent functions of design, construction, modification, up-grade still fall within the scope of the invention but not limited to all above discussion and mentioned details.

1. The plug-in LED night light with projection features consist of;
At least one LED as light source to supply visible light beams to viewer.
At least one of the optics-means incorporate with said LED or LEDs which may selected from group combination from optics-lens, film, openings, cut-outs, transparent material, translucent material, grating means, hologram means to project the desired image, message, data, logo, time on ceiling, walls, floor, desired surface.
At least one of the power source, circuit means, trigger means arranged to work with the said LED or LEDs to get desired light function, timing, colors, brightness, illumination.
The improvement including:
The said LED night light device with projection features is a plug-in type night light to connect with the outlet device.

2. The Direct Current operated LED night light with projection features consist of;
At least one LED as light source to supply visible light beams to viewer.
At least one of the optics-means incorporate with said LED or LEDs which may selected from group combination from optics-lens, film, openings, cut-outs, transparent material, translucent material, grating means, hologram means to create the desired image, message, data, logo, time on ceiling, walls, floor, desired surface.
At least one of the power source, circuit means, trigger means arranged to work with the said LED or LEDs to get desired light function, timing, colors, brightness, illumination, light effects.
The improvement including:
The said LED night light device with projection features is a direct current (D.C.) power source night light which can be turn on while the optics-lens been touched, pushed.
The said direct current (D.C.) power source means the electric signal into the said LED or LEDs is direct current which may form AC adaptor with jack, solar power source, wind power source, Chemical power, generator power, or any Direct Power source available from market.

3. The LED night light with projection features as claim 1, the said LED night light incorporated with circuit-means to make the desired light functions may selected from ground combination from fade-in and fade out, automatically changing color, sequential, random, chasing, pair flashing, time delay, time period selection, steady on, photo sensor, motion sensor, brightness changing, color changing, rotating or any available light functions available from market place.

4. The LED night light with projection features as claim 1, the optic-means may selected from group combination from optics-lens, convex lens, telescope means, concave lens, openings, cut-outs, film, grating means, hologram means (same as inventor's U.S. Pat. No. 5,667,736) to create the preferred image on the desired location to let viewer to see.

5. The LED night light with projection features as claim 1, the optics-means has geometric shape may selected from sphere, ball, half-ball, to make the image been project to x-y-z axis surface.

6. The LED night light with projection features as claim 1, the telescope with adjustable features so can change focus.

7. The LED night light with projection features as claim 1, the said LED and LEDs connected with circuit-means which may selected from group combination from circuit board, integrated circuit, conductive means, switch means, AC jack, solar module, AC plug and wire, AC adaptor, sensor means, motion sensor means, timer means to make the desired light functions and effects.

8. The LED night light with projection features as claim 2, the said LED night light incorporated with circuit-means to make the desired light functions may selected from ground combination from fade-in and fade out, automatically changing color, sequential, random, chasing, pair flashing, time delay, time period selection, steady on, photo sensor, motion sensor, brightness changing, color changing, rotating or any available light functions available from market place.

9. The LED night light with projection features as claim 2, the optic-means may selected from group combination from optics-lens, convex lens, telescope means, concave lens, openings, cut-outs, film, grating means, hologram means (same as inventor's U.S. Pat. No. 5,667,736) to create the preferred image on the desired location to let viewer to see.

10. The LED night light with projection features as claim 2, the optics-means has geometric shape may selected from sphere, ball, half-ball, to make the image been project to x-y-z axis surface.

11. The LED night light with projection features as claim 2, the telescope with adjustable features so can change focus.

12. The LED night light with projection features as claim 2, the said LED and LEDs connected with circuit-means which may selected from group combination from circuit board, integrated circuit, conductive means, switch means, AC jack, solar module, AC plug and wire, AC adaptor, sensor means, motion sensor means, timer means to make the desired light functions and effects.
